(19) United States
(12) Patent Application Publication
(10) Pub. No.: US 2026/0046575 A1
(43) Pub. Date: Feb. 12, 2026

(54) DIGITAL TINNITUS TREATMENT ELECTRONIC HEADSET, SYSTEM, AND METHOD FOR OPERATION OF SAME

(71) Applicant: ADM Tronics Unlimited Inc, Northvale, NJ (US)

(72) Inventors: Andre' DiMino, Woodclif Lake, NJ (US); Matthew DRUMMER, Fort Lee, NJ (US); Mark Brenner, Kings Lynn (GB)

(73) Assignee: ADM Tronics Unlimited Inc, Northvale, NJ (US)

(21) Appl. No.: 19/294,068

(22) Filed: Aug. 7, 2025

Related U.S. Application Data
(60) Provisional application No. 63/680,570, filed on Aug. 7, 2024.

(51) Int. Cl. H04R 25/00

(52) U.S. Cl. CPC H04R 25/75; H04R 25/505; H04R 25/606

(57) ABSTRACT

Embodiments of the present disclosure relate to an electronic headset system which is wirelessly controlled and is used to treat a tinnitus disorder. The system includes an electronic headset and an electronic communication device, such as a smartphone, a wearable device, laptop, tablet, desk top computer, server, and the like or any combination thereof. The electronic headset includes at least one treatment pad and emits complex signals which are converted into vibrations by the treatment pad and are transmitted to a user's cochlea when the electronic headset is worn, thereby alleviating the symptoms of the user's tinnitus disorder. Particularly, complex signals are applied to the Temporal Bone of the skull by the pads positioned in front of the ear, or the tragus, which is the protruding cartilage at the front of the ear. This allows the vibration to be carried by the temporal bone, through conduction to the cochlea and cilia nerves in the cochlea and other parts of the inner ear.

### CROSS REFERENCE TO RELATED APPLICATIONS

This patent application claims the benefit of U.S. Patent Provisional Application No. 63/680,570, filed on Aug. 7, 2024, the entire disclosure of which is incorporated herein by reference.

### BACKGROUND OF THE INVENTION

### 1. Field of the Invention

Embodiments of the present disclosure relate to a digital electronic headset system which is preferably wirelessly controlled and is used to treat a tinnitus disorder. The system includes an electronic headset and preferably an electronic communication device, such as a smartphone, laptop, tablet, desk top computer, server, wearable electronic device and the like or any combination thereof. Although the electronic communication device is preferably wireless, the electronic communication device can also be directly connected to the electronic headset via a wire or some other direct connection such as an electronic coupling. The electronic headset includes treatment pads and emits complex signals which are converted into vibrations by the treatment pads and are non-invasively transmitted to a user's cochlea via bone conduction of the skull from the temporal bone when the electronic headset is worn, thereby alleviating the symptoms of the user's tinnitus disorder.

### 2. Description of the Related Arts

Tinnitus is a disorder more commonly known as ringing of the ears. Though the term refers to sounds originating in the ear, the sounds may not be ringing in nature, for buzzing, humming, whistling and roaring sounds are also indicative of a tinnitus disorder, A more precise definition of tinnitus is any sound sensation for which there is no source outside of the individual.

Conventional tinnitus treatment devices on the market have many shortcomings as the conventional devices are bulky, cumbersome for a user to use, and provide little or no medical feedback information to a user and the user's medical provider, Conventional tinnitus treatment technology lacks an easy to use, statistical gathering device that can be controlled and monitored by the user and the user's medical provider.

### SUMMARY

Embodiments of the present disclosure relate to tinnitus treatment technology, particularly, to an electronic headset system which includes an electronic headset and a wireless device which controls the electronic headset. The embodiments of the present disclosure are effective for the treatment of tinnitus disorders and can be easily controlled by a user. The electronic headset system can adjust the pulse frequencies used for treatment, the duration of treatment, and can gather and store information and statistics pertaining to a user's treatment.

An embodiment of the present disclosure includes an electronic headset system having a wearable headset configured to emit adjustable Tinnitus therapy signals (“TTS”) which are received by a user through bone conduction. The characteristics of the TTS are controlled by adjusting parameters of treatment algorithms by a user using an electronic device that communicates with the headset.

An embodiment of the present disclosure includes an electronic headset system having a wearable headset configured to emit adjustable Tinnitus Therapy Signals (“TTS”) which are a product of two square waves with having a first frequency and a second frequency, the first frequency being greater than the second frequency. During treatment, the user controls the characteristics of the first frequency and the second frequency using a remote electronic device which controls the wearable device based on relief feedback experienced by the user from the wearable headset.

The treatment pad receives the complex signals from the treatment signal circuit and converts the signals into vibrations which are communicated to a user's cochlea via bone conduction of the skull from the temporal bone when the electronic headset is worn, thereby providing feedback to the user who can then adjust the vibrations of the signals to achieve maximum relief from the symptoms of the user's tinnitus disorder. Particularly, complex signals are applied to the Temporal Bone of the skull by the pads positioned in front of the ear, or the tragus, which is the protruding cartilage at the front of the ear. This allows the vibration to be caried by the temporal bone, through conduction to the cochlea and cilia nerves in the cochlea and other parts of the inner ear.

The electronic headset system further includes an electronic communication device, such as a smartphone, laptop, tablet, desk top computer, server, a wearable device, and the like or any combination thereof. The electronic communication device has an app that is used to control settings of the headset and can collect data and transmit/receive the data to the headset.

Another embodiment includes a method for operating the headset. A user puts the headset on their head and adjusts the vibrations emitting from the headset by using an app on an electronic communications device such as a smartphone to adjust the frequency of the signals emitted by the treatment signal circuit until the user feels relief from the ringing in their ears. The settings are saved in a user history file either in the headset, the app, the cloud or any combination thereof. A medical provider can access the settings of the headset to configure the headset settings and can access the user history of a user to monitor the user's progress.

The above and yet other objects and advantages of the embodiments of the present disclosure will become apparent from the hereinafter set forth Brief Description of the Drawings and Detailed Description of the Invention.

It is intended that any other advantages and objects of the embodiments of the present disclosure that become apparent from the detailed description, drawings or illustrations contained herein are within the scope of the present disclosure. It is also intended that any feature and limitation listed in an embodiment of the present disclosure can be used in any other embodiment of the present disclosure unless specifically stated otherwise. Furthermore, the embodiments may be combined to form additional embodiments.

### BRIEF DESCRIPTION OF THE DRAWINGS

The above and other object and features of the embodiments of the present disclosure will become better understood with regard to the following description of the embodiments given in conjunction with the accompanying drawings.

FIG. 1 illustrates a tinnitus headset system according to an embodiment of the present disclosure.

FIG. 2 illustrates a headset of the tinnitus headset system in figure FIG. 1.

FIGS. 3A-3C illustrate several display screens of an app which controls a headset and operates on an electronic device according to an embodiment of the present disclosure.

FIG. 4 illustrates a method for operating the headset system device according to an embodiment of the present disclosure.

FIG. 5 illustrates waveforms used to generate pain relief information signals according to an embodiment of the present disclosure.

FIG. 6 illustrates square waveforms according to an embodiment of the present disclosure.

It is intended that any feature of any embodiment of the present disclosure can be included as a feature in another embodiment of the present disclosure unless stated otherwise.

It is further intended that any other embodiments of the present disclosure that result from any changes in application or method of use or operation, method of manufacture, shape, size or material which are not specified within the detailed written description or illustrations and drawings contained herein, yet are considered apparent or obvious to one skilled in the art, are within the scope of the present invention.

### DETAILED DESCRIPTION OF THE INVENTION

Hereinafter, an embodiment of the present disclosure will be described in detail along with the accompanying drawings.

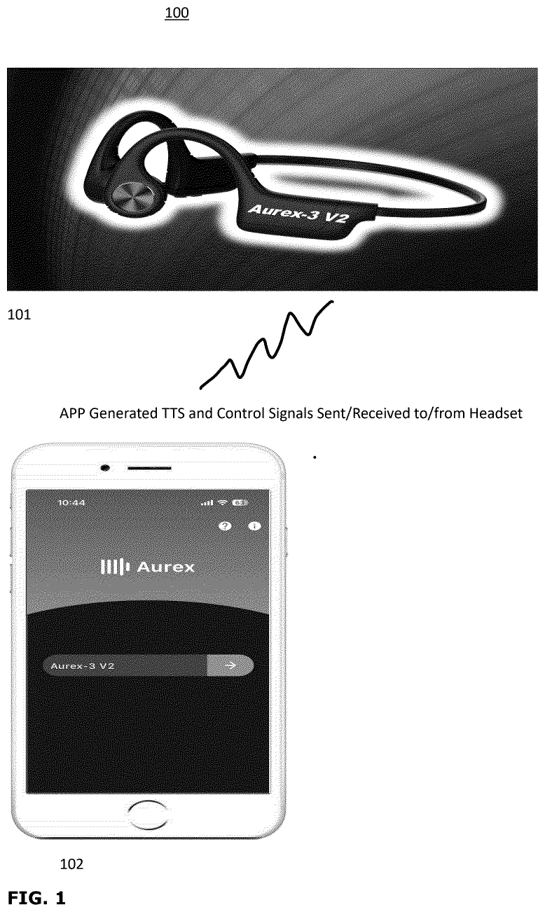

FIG. 1 illustrates a tinnitus headset system according to an embodiment of the present disclosure.

The tinnitus headset system 100 includes a headset 101 and a wireless device 102. The headset includes at least one treatment pad and emits complex signals which are converted into vibrations by the treatment pad and are transmitted to a user's cochlea when the electronic headset is worn, thereby alleviating the symptoms of the user's tinnitus disorder. The electronic headset system allows a user and a user's medical provider to adjust the settings of the electronic headset by using an app of an electronic device 102 and capture user treatment information such as the electronic headset's treatment settings, the effectiveness of particular treatment settings, and historical data related to the use of the electronic headset by a user.

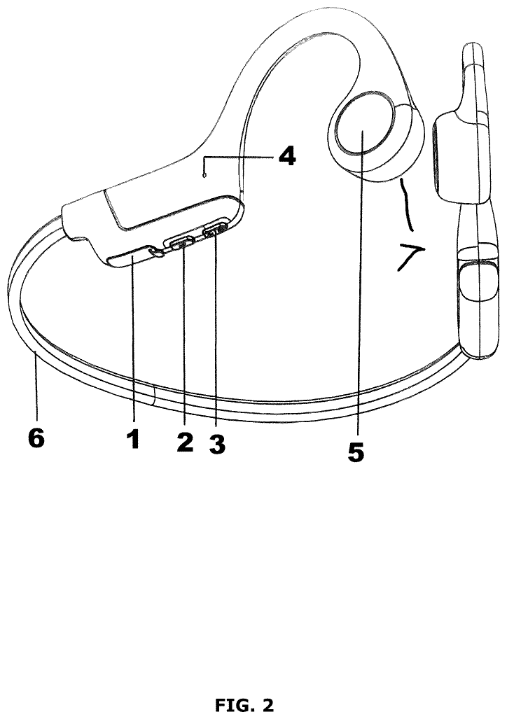

When a user uses the electronic device 102, the user selects various tinnitus headset system control functions via a display on an app which generate corresponding control signals that are transmitted to the headset from the electronic device. Both the electronic device and the headset receive and transmit signals to each other. The control signals transmitted from the app to the headset send information which sets various parameters within the headset so that the headset can generate pain relief information signals according to a process as described in FIG. 2. The pain relief information signals are converted to treatment vibrations by the headset to send the vibrations to the treatment pads of the headset worn by the user. There is a vibratory transducer disposed at the circular section in the front of the headset but the embodiments are not limited thereto. The transducer vibrates at the frequency of the signals that are applied to it which may be included in the pain relief information signals.

FIG. 2 illustrates a headset of the tinnitus headset system in figure FIG. 1.

The bone conduction headset has two sections that are placed against the front of the ear—in those sections is the transducer that vibrates in accordance with the frequencies applied to it.

Various components of the embodiments including one or more of the following:
1. Charging cover—use USB-C supplied cable
2. Volume down (−) button
3. Volume up (+) button and Power button
4. LED indicator light
5. Interrupt button
6. Illuminated band
7. Treatment Pad

The headset treatment pads 7 generate vibrations which are felt by a user through treatment pads on the headset. The vibrations are based on Tinnitus therapy signal (“TTS”) frequencies which are controlled by a processor in the headset. The first frequency of the TTS may be perturbed every 100 ms by about 1% to 10% and restored to a base first frequency every 50 ms over a positive sinusoidal function but the embodiments are not limited thereto. The term “perturbed” refers to a frequency that has been altered by logic included in a component of the wearable headset. The term “about” refers to a deviation of plus or minus 0.5 from listed values which it describes.

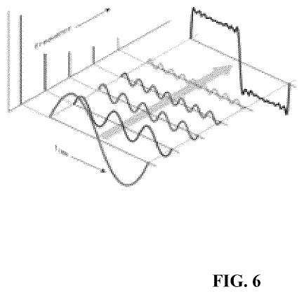

The TTS signal is the product of two square waves (See FIG. 6) with frequencies f1 and f2. Frequency f1 is greater than f2.

### High Frequency Signal

A square wave with a high base frequency between 600 and 1000 Hz that is set by the user.

Periodically every 80 to 100 milliseconds the high base frequency is perturbed by increasing the frequency according to an analog function cycling back to the base high frequency taking between 15 and 20 milliseconds. The analog function also has a random short duration, 1 to 5 millisecond increase cycles in addition to the main 15 to 20 millisecond perturbation.

### High Frequency Base: HFB

Perturbation Frequency: PF=f(t), Where the frequency is a function of time.

High Frequency Signal Square Wave: HFS=HFB+PF

### Low Frequency Signal:

### Low Frequency Signal: LFS

A square wave with a frequency between 200 and 400 Hz that is set by the user.

### Output Signal Harmonic:

The output signal (OSH) is a square wave that contains a lower harmonic that represents the difference between the High Frequency Signal (HFS) and the Low Frequency Signal (HFS).

Output Signal Harmonic: OSH=HFS−LFS

When taking into account the Perturbation Frequency (PF), where the major changes are at a frequency between 100 to 120 Hz, additional lower frequency harmonics may be formed.

$$OSH = HFS - ( LFS + PF )$$

Thus, the full output signal contains everything:

HFS (600 to 1000 Hz) and LFS (200 to 400 Hz) AND the lower output harmonics (OHF) (100 to 120 Hz).

As an example, in another embodiment f1=750 Hz and f2=353 Hz

The Base Frequency 750 Hz+10−1TIME HH:MM:SS.SSS

Perturbation by 100 Hz half rectified sine wave that alters the Base f1 frequency TIME HH:MM:SS.SSS+0.010−0.01

This generates variations in the base f1 frequency for 50 ms every 100 ms.+10−1TIME HH:MM:SS.SSS

This generates a low frequency rumble.

The Lower f2 frequency at 353 Hz+10−1TIME HH:MM:SS.SSS

The frequency perturbed f1 frequency is then combined with the lower f2 frequency by multiplication to create the output waveform.

+10-1TIME HH:MM:SS.SSS

Similar modification may be performed with a base signal of 500 Hz. This results in 2 TTS settings, one with a base frequency of 750 Hz and another with a base frequency of 500 Hz, selectable by the user, depending on the user's frequency of tinnitus. Additional signal pairs can be created as well so long as the combination creates a rumbling effect from the pairing.

Central to the approach of embodiments of the present disclosure is the application of beat harmonics.

Traditionally, dissonance has been widely believed to be the product of “beating”: interference between frequency components in the cochlea that has been believed to be more pronounced in dissonant than consonant sounds. However, harmonic frequency relations, a higher-order sound attribute closely related to pitch perception, has also been proposed to account for consonance. Some combinations of musical notes sound pleasing and are termed “consonant,” but others sound unpleasant and are termed “dissonant.”

Conventional technology regarding consonance is that it is rooted in acoustics, beginning with the fact that musical instrument and voice sounds are composed of multiple discrete frequencies. These frequencies are termed “harmonics” because they are typically Integer multiples of the fundamental frequency of the sound. Harmonics are combined in a single waveform when traveling in the air but are partly segregated by the cochlea, because different auditory nerve fibers respond to different frequencies.

When several musical notes are combined, the resulting sound waveform that enters the ear contains all individual frequencies of each note, Auditory scientists have long noted that aspects of the pattern of component frequencies differ between consonant and dissonant chords. Prevailing theories ascribe consonance to the fact that dissonant chords contain frequency components that are too closely spaced to be resolved by the cochlea, Two such components shift in and out of phase over time, producing an interaction that oscillates between constructive and destructive Interference. The amplitude of the combined physical waveform thus alternately waxes and wanes. If the components are close enough to excite the same set of auditory fibers, amplitude modulations are directly observable in the response of the auditory nerve. These amplitude modulations are called “beats,” and result in an unpleasant sensation known as “roughness,” analogous to the tactile roughness felt when touching a corrugated surface. In practice, the perception of roughness is dependent on the depth and rate of amplitude modulation, as well as the center frequency of the tones involved. Theories of dissonance based on beating have been dominant in the last century and are now a regular presence in current technology.

However, a second acoustic property also differentiates consonance and dissonance: the component frequencies of the notes of consonant chords combine to produce an aggregate spectrum that is typically harmonic, resembling the spectrum of a single sound with a lower pitch. In contrast, dissonant chords produce an inharmonic spectrum. Such observations led to a series of analyses and models of consonance based on harmonicity. Although beating-based theories are widely accepted as the standard account of consonance, harmonicity has remained a plausible alternative, that is, harmonicity is more closely related to consonance than it is to beating.

This disassociation of harmonicity from beating in the embodiments of the present disclosure and its unique matching to a user's Tinnitus sound presents a unique and differentiated model and modality for Tinnitus treatment.

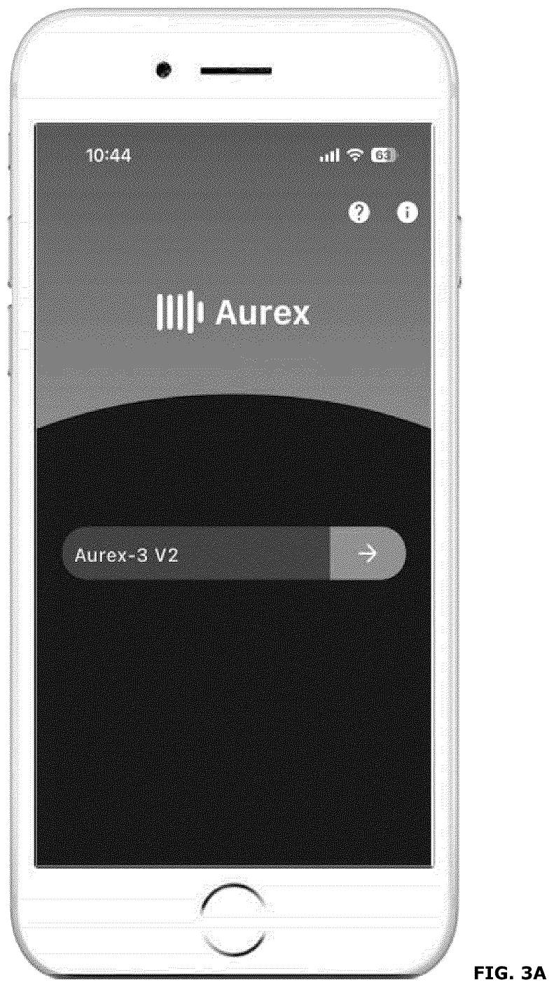

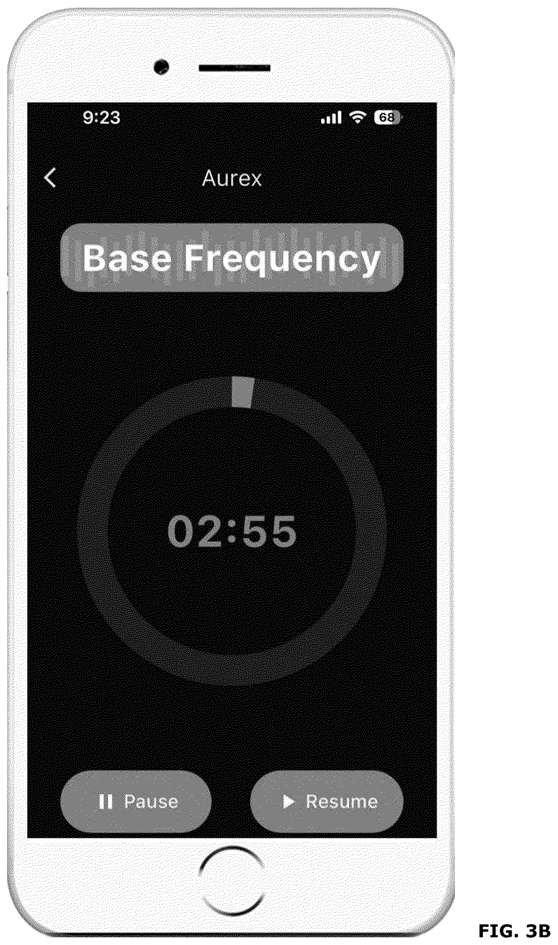

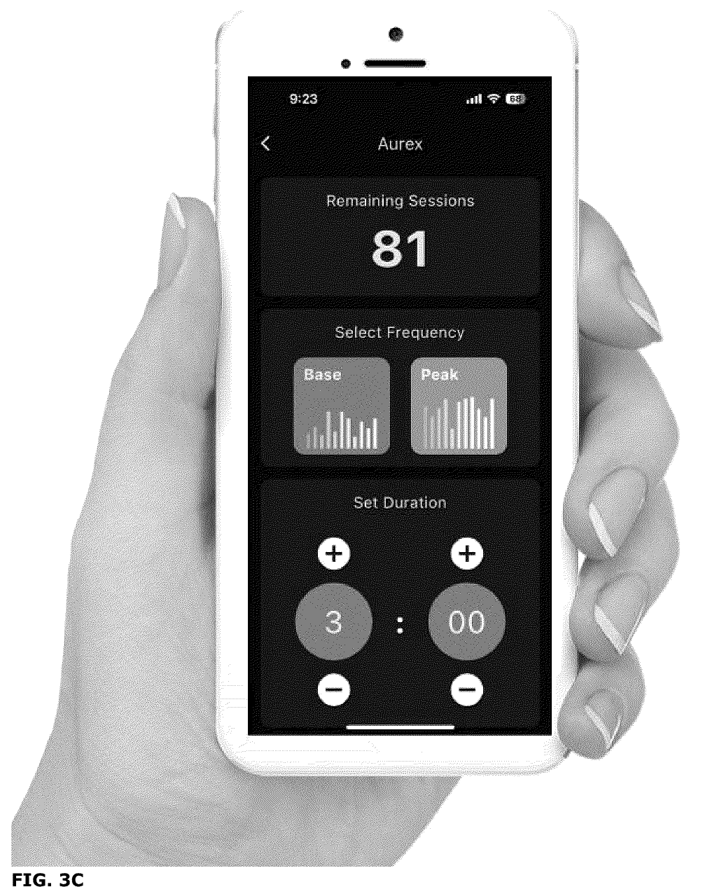

FIGS. 3A-3C illustrate several display screens of an app which controls a headset and operates on an electronic device according to an embodiment of the present disclosure.

FIG. 3A Illustrates a home screen of an app which controls the Tinnitus Headset System.

FIG. 3B Illustrates time of the applied base frequency for treatment on a screen of an app which controls the Tinnitus Headset System.

FIG. 3C Illustrates a base and peak frequencies for treatment on a screen of an app which controls the Tinnitus Headset System.

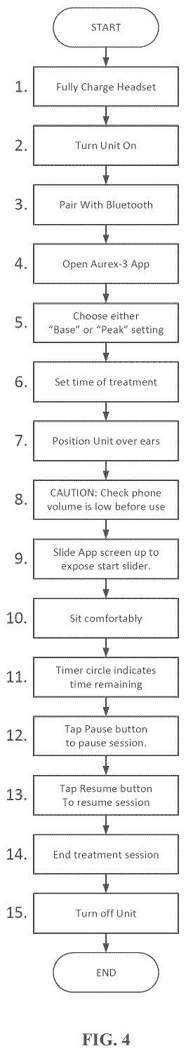

FIG. 4 illustrates a method for operating the headset system device according to an embodiment of the present disclosure.

Referring to FIG. 4, the following procedures occur in the recited order but the embodiments are not limited thereto and other combinations of the order of procedures recited including omission, addition, or rearrangement of the procedures are included in embodiments thereof. Referring to FIGS. 2 and 4, embodiments of the operation of the headset system include one or more of the following procedures:

1. Fully charge: Open the Charging cover (1) insert suppled USB-C cable and connect to USB-C power source. Only charge with computer USB port or charger with DC5V+/−0.25V. LED Indica-tor light (4) will be red when charging and turn blue when fully charged.

2. Turn Unit on by long-pressing side of the Volume up button (3) at the power symbol. Unit will announce “Power On”.

3. Pair with Bluetooth by selecting E7 on phone. When paired, Unit will announce “Connected.”

4. Open Aurex-3 App and enter Account Number in center space to left of Arrow then tap arrow.

5. Choose either “Base” or “Peak” setting.

6. Set time of treatment session by increasing or decreasing minutes and seconds.

7. Position Unit over ears so red conduction pads rest comfortably on or against Tragus.

8. CAUTION: Be sure phone volume is low before starting treatment. Once treatment begins, gradually increase volume until comfortable.

9. Slide App screen up to expose start slider. Slide to right to start treatment session.

10. Sit comfortably during treatment session.

11. During treatment session, countdown timer circle indicates time remaining.

12. Tap Pause button to pause session.

13. Tap Resume button to resume session.

14. To end treatment session prior to set time, slide bottom slider to terminate. Note: if phone call is received during session, reject call by long pressing Interrupt Button (5). Treatment session will be paused, to continue session touch Resume button on App.

15. Turn off Unit by long-pressing Power Button (3). Unit will announce “Power Off”.

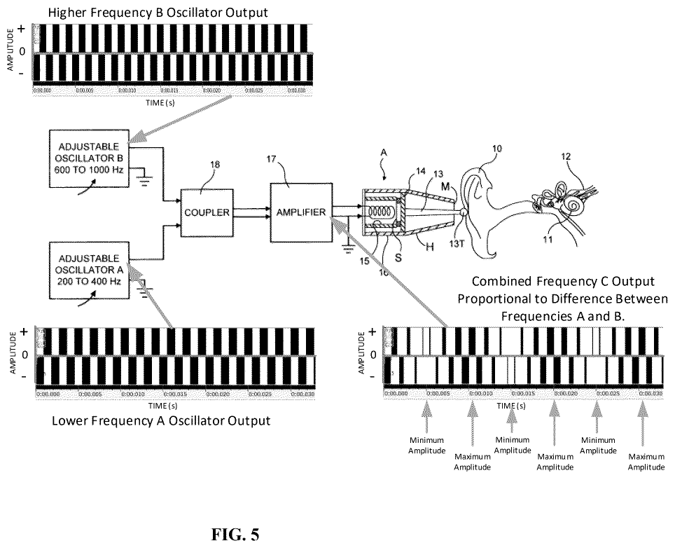

FIG. 5 illustrates waveforms used to generate pain relief information signals according to an embodiment of the present disclosure.

Referring to FIG. 5, waveforms are shown at key points in the block diagram.

The first frequency is a lower frequency square wave generated from oscillator A. The second higher frequency square wave is generated from oscillator B. Frequency A and B are combined in coupler (18) and fed to amplifier (17). The wave form generated is a combination of both frequencies that generates a third frequency C that is proportional to the difference of the two initial frequencies A and B. Frequency C is much lower than either A or B. The diagram shows points of maximum and minimum amplitude activity.

The Square waves themselves are a summation of sine waves with frequencies with odd multiples (1,3,5,7 . . . ) of the main frequency.

FIG. 6 illustrates a concept of square waveforms according to an embodiment of the present disclosure.

Referring to FIG. 6, the square wave in black is the summation of sine waves starting from the 1^{st} harmonic in red having the same frequency as the square wave.

Lower odd harmonics (3^{rd} blue, 5^{th} Green, 7^{th} purple, and 9^{th} yellow) at lower amplitudes are summed together to produce a square wave

While the embodiments of the present disclosure have been described with respect to certain embodiments, it will be apparent to those skilled in the art that various changes and modifications may be made without departing from the scope and spirit of the invention. Furthermore, the embodiments may be combined to form additional embodiments.

What is claimed is:

1. A method of using harmonicity to treat tinnitus, the method comprising:
Positioning an electronic headset including at least one treatment pad and a treatment signal circuit on a user, such that the at least one treatment pad contacts a temporal bone of the user;
Receiving, by the at least one treatment pad, adjustable Tinnitus Therapy Signals (“TTS”) from the treatment signal circuit;
Converting, by the at least one treatment pad, the TTS into vibrations which are communicated to a user's cochlea via bone conduction of the skull from the temporal bone
Adjusting characteristics of a first frequency and a second frequency of the TTS by the user using a remote electronic device which controls the treatment signal circuit based on relief feedback experienced by the user;
Wherein adjusting characteristics of the first frequency and the second frequency includes creating the TTS which are a product of two square waves having a first frequency and a second frequency, the first frequency being greater than the second frequency.
